(19) United States
(12) Patent Application Publication
(10) Pub. No.: US 2023/0248110 A1
(43) Pub. Date: Aug. 10, 2023

(54) Rapidly Manufacturable Shoe Having Custom Midsole and System and Method for Rapidly Manufacturing Shoe with Custom Midsole

(71) Applicant: Stephen M. Levine, Springfield, MO (US)

(72) Inventor: Stephen M. Levine, Springfield, MO (US)

(21) Appl. No.: 18/106,973

(22) Filed: Feb. 7, 2023

Related U.S. Application Data
(60) Provisional application No. 63/307,298, filed on Feb. 7, 2022.

(51) Int. Cl. A43B 17/00; A43D 119/00; B33Y 10/00; B33Y 80/00; B33Y 50/00; B29D 35/12

(52) U.S. Cl. CPC A43B 17/003; A43D 119/00; B33Y 10/00; B33Y 80/00; B33Y 50/00; B29D 35/122

(57) ABSTRACT

A process and system allow for rapid customization and fabrication of the midsole layer of a shoe for the mass manufacturing of shoes with custom midsoles. A partially manufactured shoe is made, a style is selected by the wearer, and a custom midsole is rapidly designed, and incorporated in the partially manufactured shoe style selected by the wearer. Also, in some shoes, reorganization relocates the midsole to the interior of the shoe during manufacturing.

This application claims the benefit of U.S. Provisional Application No. 63/307,298, filed Feb. 7, 2022, which is hereby incorporated by reference herein in its entirety.

### BACKGROUND

### Field of Invention

Embodiments relate to custom midsoles and manufacturing of same in an easy, cost-effective manner. More specifically, a partially manufactured shoe having no, or only a partial, midsole is provided that is configured to stably accommodate insertion of a rapidly customized midsole to make a fully functional shoe.

### Background

The sole of a conventional shoe comprises 4 layers. Listed from dorsal to plantar, these layers are (1) the insole. (2) the shoe lasting (found in athletic shoes or comfort dress shoes). (3) the midsole, and (4) the outsole. Typically, the insole is a thin, sometimes removable, layer of material that is located within the shoe, and the layer which contacts the bottom of the wearer's foot or sock worn by the wearer. The “lasting” or “shoe lasting” is the layer of material between the insole and midsole. The lasting layer refers to the technique used to attach the upper to the midsole (board, slip or combination lasting). This technique results in a thin layer of material between the insole and the midsole. The midsole is the layer of material between the insole, or, if present, the shoe lasting, and the outsole.

The midsole layer is typically made of a material that provides cushioning and shock absorption, such as EVA (ethylene vinyl acetate), cork or polyurethane derivatives (i.e., thermoplastic polyurethane). This may be combined with specialized materials such as gel or air. In many cases, particularly with athletic shoes, the midsole layer is visible when viewing the outside profile of the sole of the shoe. When so viewed, it often appears as a thick foam or rubber like material that runs the length of the sole. Shoe manufacturers use the midsole layer to create the functional layer of the shoe because it is often the thickest layer of the shoe sole. An example of the functionality of the midsole layer is in running shoes where, for example, companies use a dual or multi-density midsole layer to make motion control shoes to improve the function of flat feet, add an air bladder or gel for increased shock absorption, etc.

Typically, the outsole is a firm rubber-like material, such as rubber, polyurethane. PVC compounds. EVA or leather. In shoes, the outsole is commonly referred to as the tread or cleat. The outsole is the layer of the sole that makes direct contact with the ground. In some shoes, the outsole is somewhat continuous with the midsole layer where the tread pattern is stamped or molded onto the undersurface of the midsole layer. Such an outsole is sometimes seen in athletic shoes.

For myriad reasons, conventional shoes are not always comfortable for wearers. Reasons for the discomfort include lack of arch support, inability to accommodate or align lower extremity or foot deformities, and an inability to customize to treat lower extremity pathology. To alleviate these issues, users conventionally resort to custom-made or over-the-counter foot orthotics or insoles. Custom-made orthotics or insoles can be designed to add comfort to a user in a number of ways including supporting, aligning, or cushioning a user's foot, accommodating deformity or bony prominences, and preventing or treating lower extremity, and even low back, pathology or injuries. Because they are not customized to a particular user's needs, over-the-counter foot orthotics or insoles, on the other hand, are generally limited in their function because they only provide arch support which may be too high or too low for a user because they are designed for the average arch height, not the arch height of a specific user. Furthermore, over- the -counter orthotics/insoles are often not firm enough to provide adequate arch support.

Conventional shoes present challenges for using custom-made or off-the-shelf orthotics or insoles that limit the degree of shoe insole customization that is possible. Chief among these challenges is that conventional shoes are not specifically designed or manufactured to handle the bulk of an inserted orthotic or insole. Instead, they are designed only to accommodate the insole originally designed for and originally inserted into the shoe. The bulk of an inserted orthotic or insole may cause issues with shoe fit because the inserted orthotic or insole takes up interior space in the shoe that would otherwise be available for the user's foot. As a result, the shoe might be too tight if an insole or orthotic is added to a conventional shoe.

Also, since conventional shoes are not manufactured to house orthotics, such orthotics may not be stably seated within the shoe. Consequently, such orthotics may interfere with foot-to-ground proprioception. In the context of a person's foot while walking or standing, proprioception refers to a person's ability to sense the position of their foot in relation to the ground. Proprioception is important in preventing sprains and other injuries of the foot and ankle. Proprioceptive abilities are at their peak when the foot is in direct contact with the ground. However, proprioceptive abilities decrease as the height of materials placed beneath the foot increases, such as the insole, lasting, if present, midsole, outsole, or any additional insole or orthotic. Thus, as more material is added between the user's foot and the ground the chance for proprioceptive abilities to be compromised increases. An unstable seated orthotic, along with the added height, can cause further proprioceptive ability compromise.

Another problem with insoles or orthotics is they generally involve a separate, often expensive, purchase. The expense is greatly increased in the case of custom insoles or orthotics. Moreover, custom insoles or orthotics generally require several weeks to manufacture and additional visits to fit and adjust the device.

Manufacturers have attempted to overcome some of the shortcomings of mass-produced footwear by producing shoes with various modifications to the sole layer. Comfort footwear brands, such as Vionic, have added a standard arch support to the insole or midsole layer of various shoe styles (sandals, wedge shoe, dress shoes etc.). However, because the arch support is of a median height, wearers with flat feet will often not tolerate the arch due to excessive pressure, and wearers with high arch feet will often not have any benefit because the arch of the shoe is too low. Furthermore, conventional methods for using custom orthotics to optimally align or address foot pathology for particular users are performed on a case-by-case basis. Current methods employed do not allow for rapid customization of the sole layer of shoes so that all wearers can be optimally fit. 3D printing an entire shoe (including uppers) is currently a slow process, costly to the consumer, and limited to specific printable materials.

For example, manufacturers of running shoes have attempted to produce various models of shoes to address mechanical issues of various foot types such as overpronation and under-pronation. They generally focus their efforts on the midsole layer because it is the thickest part of the shoe, and therefore allows for the greatest degree of modification. For example, to better support a flat foot, motion control running shoes have a firmer medial side of the midsole and softer lateral side. For high arch feet, which poorly absorb shock, manufacturers typically design a thicker midsole or use materials which better absorb shock.

Aside from the issue of comfort of conventional shoes, users often have specific requirements for the midsole portion of their shoes, particularly in the case of athletic shoes. For example, users may desire a certain midsole thickness, heel-to-toe drop, degree of toe spring or rocker sole, and firmness or flexibility of the shoe. For example, a runner who runs on hard surfaces may desire a thicker midsole with a softer material than a runner who runs on a soft track or grass. However, meeting this need for particularized midsoles for various uses has resulted in the need for shoe manufacturers to add more “Stock keeping Units” (SKU's) to their inventory. This can be laborious, space consuming, and costly.

Another problem shoe manufacturers face when it comes to customization is the limitation on the degree to which shoe manufacturers can contour and modify midsoles because they want their shoes to be comfortable on as many users' feet as possible to increase sales. But, because every user's foot is different, customization of a shoe can be optimized only if the sole is customized to the particular user's foot. An efficient method of mass producing customized soled shoes has yet to be disclosed.

### SUMMARY

Embodiments allow rapid and cost-efficient manufacturing of a shoe with a custom midsole. In an embodiment, a user (also referred to as a wearer or consumer herein) selects a shoe style whether virtually, for example, via a website or from a catalog, or from a physical selection of various shoe styles, for example in a shoe store or kiosk. After the user selects the shoe style, a partially manufactured shoe is made. In an alternative embodiment, a user can select from a number of partially manufactured shoes of various styles that are pre-made, and the pre-made partially manufactured shoe of the style selected by the user is used. As used herein, a partially manufactured shoe is partially manufactured in the sense that it has no, or only a partial, midsole, but is otherwise complete. That is, in the partially manufactured shoe, the midsole that would otherwise be present in a conventional shoe is either partially or fully omitted. In another embodiment, a number of partially manufactured shoes are made of various shoe styles from which a user can select a partially manufactured shoe corresponding to a specific shoe style he or she desires. Using a partially manufactured shoe effectively reorganizes the shoe to allow rapid insertion of a custom midsole without sacrificing comfort of the wearer. In the reorganization of a shoe according to embodiments, the midsole is relocated either wholly or partially to the inside of the shoe.

Based on user preferences and/or needs, a custom midsole is designed and inserted into the partially manufactured shoe to complete manufacturing of the shoe to be worn by the user. The custom midsole is inserted on top of the outsole if there is no partial midsole in the partially manufactured shoe or on top of the partial midsole if there is a partial midsole in the partially manufactured shoe. In an embodiment, there may be a thin layer known as a shoe lasting, or other such thin layer of material that lays between the outsole and the interior of the shoe. The custom midsole can be inserted in a fixed or removable manner by adhering the custom midsole to the top surface of the outsole or partial midsole present in the partially manufactured shoe. Where there is a shoe lasting, or other such thin layer of material, the custom midsole is fixedly or removably adhered to the shoe lasting, or inserted on top of the shoe lasting.

For consumers, embodiments provide a rapid method to obtain customized shoe gear that will optimize comfort and foot function by providing custom arch support, aligning the foot and lower extremity and being able to accommodate and alleviate foot deformity and pain through the customization of the midsole. Wearer's will be provided the option to have the midsole layer of their shoe fully customized with all modifications known in the art of custom foot orthotic making and midsole design. For example, but not limited to the following examples, runners can select the amount of toe spring, arch support, heel to toe drop, thickness and firmness of the midsole; Neuropathic patients prone to ulceration can utilize aperture modifications to offload high pressure points on the sole of the foot; wearer's with a limb length discrepancy can select to make the midsole thicker on the shoe that will be worn on the shorter leg; wearers with flat feet can select modifications and materials to better align their feet; wearers with high arch feet can select materials that will absorb shock optimally as well as selecting an arch height that will be in full contact with their feet to further alleviate and distribute ground reactive forces. The custom midsole precludes the need to purchase additional custom or over-the-counter foot orthotics. The shoe and custom midsole as described in embodiments of this invention allow for the custom device to be stably seated in the shoe and allow for the wearer's foot to comfortably fit. Since additional material will not be added beneath the wearer's foot (such as custom or over the counter foot orthotic/insole) proprioceptive abilities are enhanced which may prevent injury.

Embodiments provide a significant competitive advantage for shoe companies. Midsole customization is efficient and cost effective. Shoes made according to embodiments are highly desirable due to personalization, increased comfort, and the biomechanical and accommodative benefits of midsole customization. Manufacturing costs can be reduced because shoe companies will not have to use more expensive midsole layers such as air, gel, etc. Further, shoe companies will be able to reduce the numbers of SKUs to accommodate consumers with different foot types, foot or lower extremity issues, or back problems, thereby lowering space, labor, and inventory costs. For example, running shoe companies will no longer need to manufacture various shoe models, which include neutral, stability, motion control, and cushion, that exist to improve the function of various foot types (neutral, overpronator, and underpronator).

In an embodiment, a shoe includes a partially manufactured shoe having a midsole layer that is partially or fully omitted and a custom midsole that is inserted into the shoe. In an embodiment, the partially manufactured shoe is configured such that the custom midsole fits within the shoe with sufficient room for a wearer's foot. In an embodiment, the collar of the shoe is lowered under the ankle malleolus to prevent irritation if the custom midsole is thin enough that the user's ankle malleoli would rub against the collar of the shoe.

In an embodiment, a method for manufacturing a shoe having a custom midsole includes partially manufacturing shoes of one or more styles that have one of no midsole and a partial midsole, selecting a style of shoe from the one or more styles, fabricating a custom midsole; optionally covering the custom midsole with an insole, and inserting the custom midsole into the shoe to form a complete shoe, wherein the partially manufactured shoe has uppers that are extended or heightened to accommodate the inserted custom midsole. In an embodiment, the method for manufacturing a shoe includes capturing an image of a wearer's foot, designing the custom midsole using the captured image of the wearer's foot, creating a model of the custom midsole based on the design of the custom midsole, and fabricating the custom midsole based on the model.

### BRIEF DESCRIPTION OF THE FIGURES

FIG. 1 is a flow chart of a process for making a shoe with a customized midsole and optional insole according to an embodiment of the present invention.

FIG. 2 is a schematic diagram of a system for making a shoe with a custom midsole and optional insole according to an embodiment of the present invention.

FIG. 3A illustrates an example of the computer aided design (CAD) of the custom midsole based off of a foot scan.

FIGS. 3B and 3C shows a pedobarograph force mat and the resultant electronic image produced.

FIGS. 3D-3F shows an example of milling machines and the milled custom midsoles.

FIG. 4 illustrates a shoe with a custom midsole using a partially manufactured shoe, and manufactured according to an embodiment of the present invention compared to a conventionally manufactured shoe.

FIG. 5A illustrates a conventional shoe using straps for uppers compared to a shoe that uses straps for uppers according to an embodiment of the present invention.

FIG. 5B illustrates a partially manufactured shoe using straps as uppers made according to an embodiment.

FIG. 5C illustrates a custom midsole designed and fabricated as described above for insertion into a shoe with straps as uppers.

FIG. 5D illustrates a partially manufactured shoe using straps as uppers made according to an embodiment.

FIG. 5E illustrates a shoe 530 that uses straps for uppers that comprises a custom midsole 503 according to an embodiment of the present invention

FIG. 6A illustrates a sagittal profile slice of a conventional shoe.

FIG. 6B illustrates a sagittal profile slice of a shoe according to an embodiment of the present invention.

### DETAILED DESCRIPTION

Embodiments of the present invention provide an efficient, cost-effective system and method for rapidly and easily fabricating a shoe having a custom midsole layer, also referred to herein as a custom midsole. During manufacturing of a shoe according to embodiments, the custom midsole is designed according to user requirements, and inserted into a partially manufactured shoe that has no, or only a partial midsole. Optionally, the custom midsole layer is covered with an insole layer that conforms to the contour of the dorsal portion of the custom midsole. Optionally, the insole layer can be adhered to and/or placed on top of the midsole layer.

Customization of the midsole according to embodiments can be used to increase comfort, accommodate and/or treat a number of maladies, including without limitation, arch support, over- and under -pronation, lower extremity alignment, lower extremity or foot deformities, treatment of lower extremity or foot pathology, to offload areas of excessive pressure, offload areas that are ulcerative or pre-ulcerative (such as in a neuropathic foot), and treatment of lower back issues. In one application, for example, modification of either the full or partial length thickness of the midsole can be used to accommodate a significant leg length discrepancy. Such accommodation can be accomplished by making one midsole thicker than the other. Such accommodation cannot be accomplished with a custom foot orthotic that is designed to be placed into a shoe with an already existing permanent midsole layer due to the inability of the conventional shoe to accept the necessary thickness.

Embodiments preclude users from having to purchase separately custom or over-the-counter foot orthotics because their shoe will come with a custom device. Time and expense are saved because the consumer will receive the custom midsole at the time they receive their shoe.

Embodiments allow for a midsole to be rapidly customized on site, and rapidly replaced if overly worn or compressed.

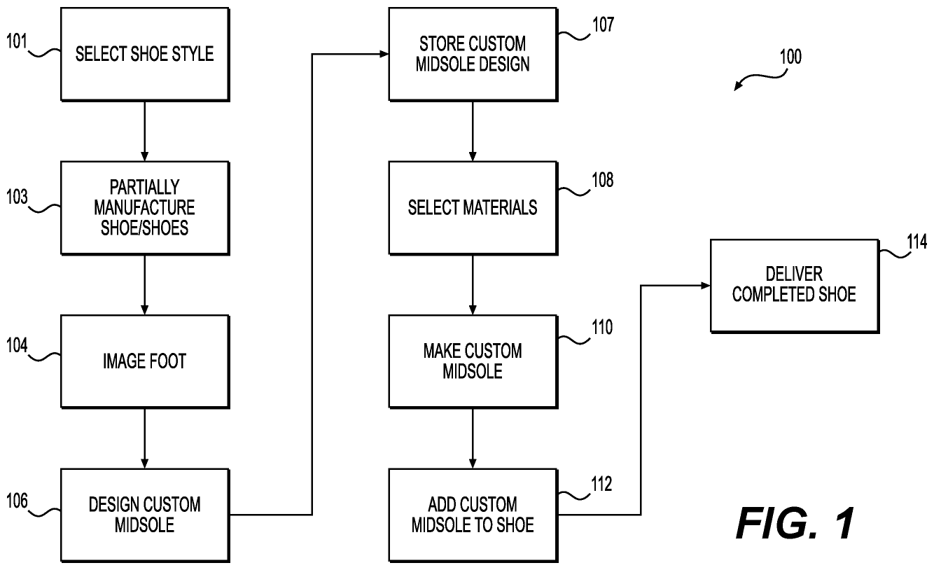

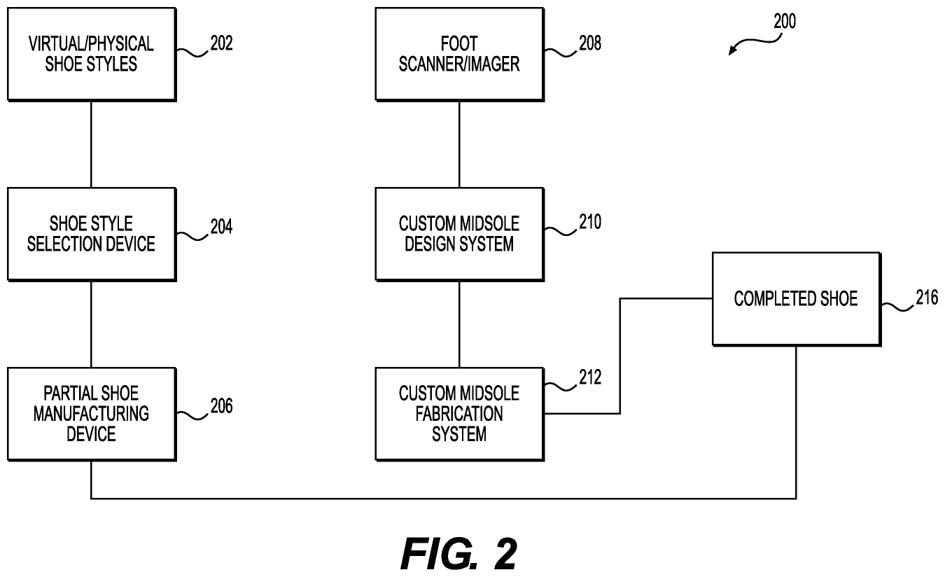

FIG. 1 is a flow chart for a process 100 for making a shoe with a custom midsole according to an embodiment. FIG. 2 is a schematic diagram 200 of a system for making a shoe with a custom midsole and optional insole according to an embodiment.

In step 101, a user selects a shoe style from a selection of shoe styles 202. A user can be a wearer of the shoe, and can be for example a consumer desiring to purchase a shoe, a patient requiring customized footwear, or any other person desiring customized footwear. Alternatively, a user can be a professional that designs custom midsoles using embodiments, someone desiring to purchase a gift for another, or any other person or entity desiring to purchase or make customized footwear. Shoe style selection 202 can be virtual or physical. Virtual shoe style selection 202 can be any virtual selection of shoe styles, including, for example, selection of shoe styles displayed on a web browser from a web site, or a catalog of shoe styles. In an embodiment, for example, to select a shoe style virtually a user uses a selection device 204. Selection device 204 can be any device that can be configured for selecting the shoe style from selection of shoe styles 202 according to an embodiment. For example, in an embodiment, selection device 204 is a computer having a display, wherein a web browser executing on the computer connects to a web site that displays exemplary shoe styles for selection to the user on the display, and selection is made using a pointing device such as a computer mouse or touch screen. Alternatively, selection device 204 can be a computer with a display, wherein the computer has executing thereon a dedicated application that displays exemplary shoe styles to a user for selection using, for example, a pointing device such as a computer mouse or touch screen. Myriad selection devices 204 would be known to those skilled in the art including personal computers, laptop computers, smartphones, computer tablets, etc.

Physical selection can be any form of physically selecting shoe styles. In an embodiment, for example, a user selects a shoe style from a selection of shoe styles displayed in a shoe store or professional's office. Any other virtual or physical way of selecting shoe styles can be used.

Shoe styles 202 comprises any shoe style that can accept a custom midsole according to embodiments. Exemplary styles include, but are not limited to, athletic shoes (including any style of sports specific shoes, from running sneakers to cleats), sandals, wedges shoes, dress shoes, high-heel shoes, including high-heel shoes with or without strap uppers, boots, and clogs.

According to embodiments, the midsole is customized at the time of order or making the shoe by a user, a professional skilled in the art, or an automated computer algorithm. Once made, the custom midsole is permanently or removably inserted into or adhered to the partially manufactured shoe atop the outsole or, if present, partial midsole. In an embodiment, a shoe lasting, or other thin layer of material may separate the outsole or partial midsole (if present) from the custom midsole. In an embodiment, a custom midsole is optionally covered with an insole. In such a case, the insole would conform to the customized midsole's dorsal surface.

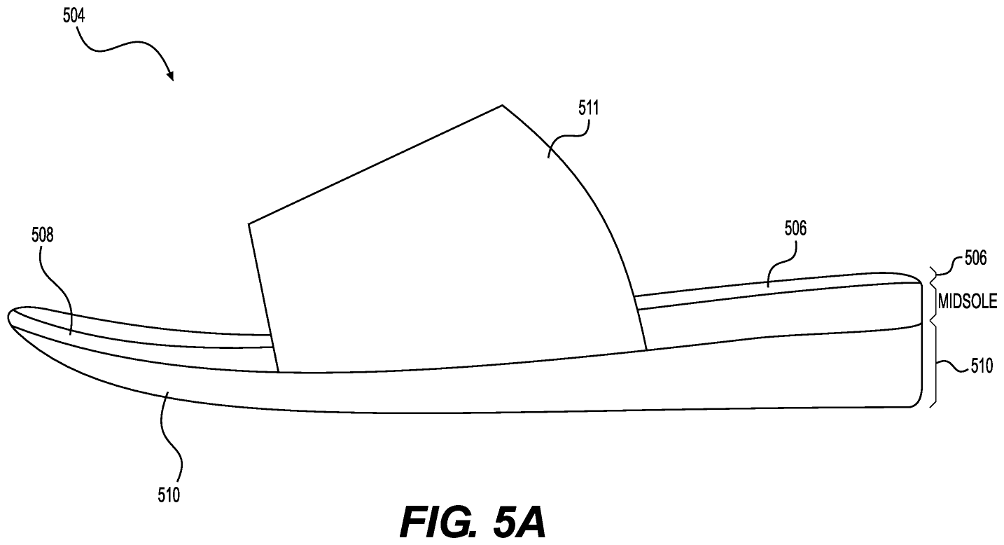

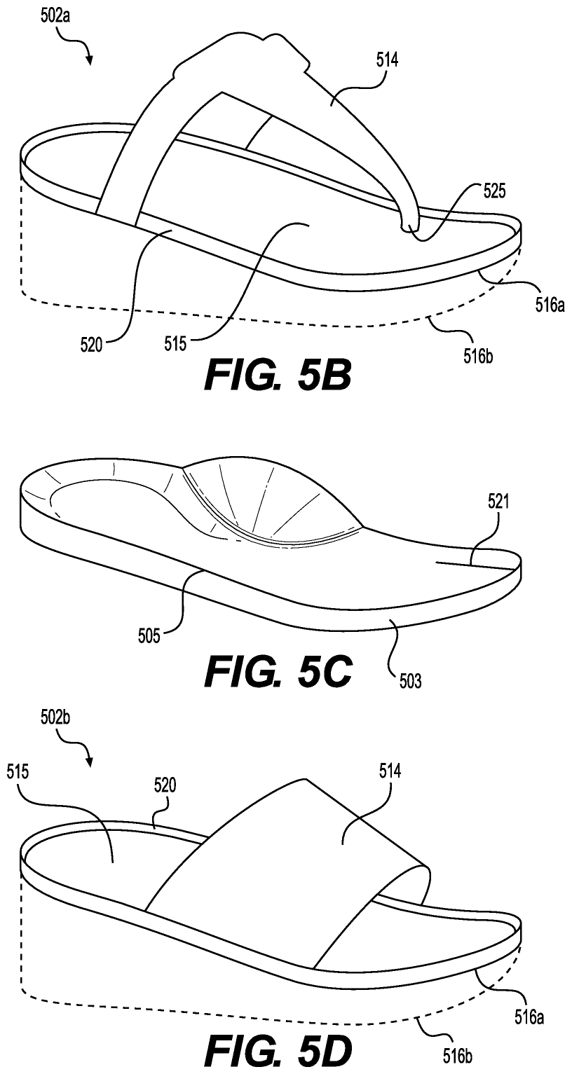

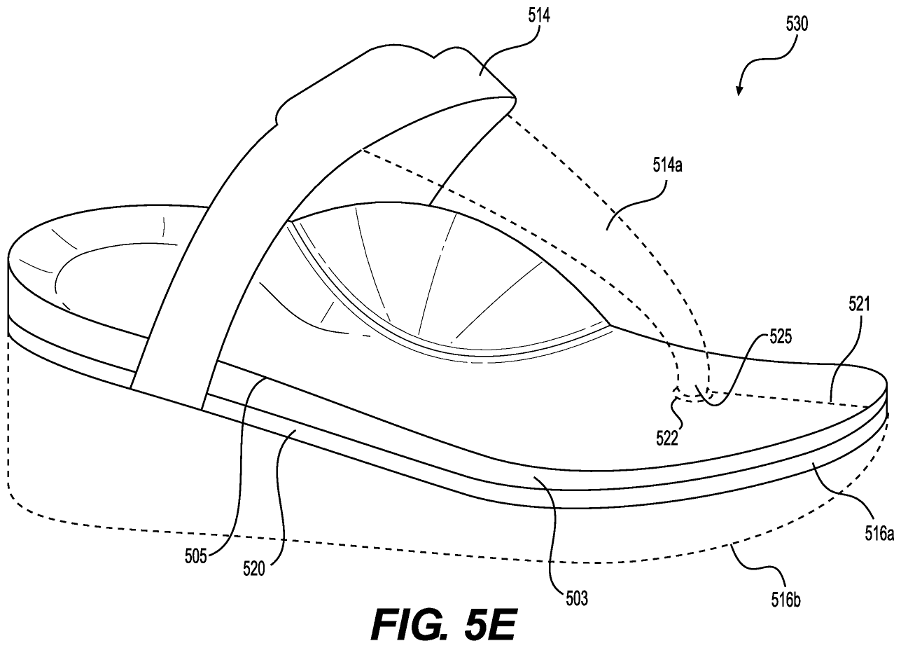

In step 103, a shoe of the style selected by the user is partially manufactured using a partial shoe manufacturing device 206. A partially manufactured shoe has no, or only a partial, midsole, and is configured as described below to accept insertion of a custom midsole according to embodiments, and only a portion of the custom midsole (partial midsole) or none of the custom midsole is included. In embodiments where there is a partial custom midsole in the partially manufactured shoe, only a portion of the partial custom midsole is visible. (unless the shoe uppers are transparent), that is, in such an embodiment, a portion or all of the partial custom midsole is covered by the shoe uppers. With respect to sandals, wedge sandals, or other shoes that use straps as uppers, a partially manufactured shoe is described with respect to FIG. 5B.

Shoe styles can also be partially manufactured using partial shoe manufacturing device 206 prior to user selection of shoe styles. Such prior manufacture of a partially manufactured shoe or shoes may be advantageous, for example, in a brick-and-mortar store or kiosk, where physical examples of partially manufactured shoe styles are available for consumers to view and select, to improve efficiency in a fulfillment center, or in a professional's office.

In an embodiment, a partially manufactured shoe includes uppers, and an outsole. In an embodiment, uppers can include a securing device such as shoe laces, elastic, Velcro, buckle, and the like. Optionally, a partially manufactured shoe contains a partial midsole, a shoe lasting or other thin layer of material that separates the outsole or partial midsole from the interior of the shoe, and/or a shank. Where a partial midsole is included, the partial midsole may or may not be visible on the exterior of the shoe. In embodiments, the upper portion of the shoe may include any features known in conventional shoe manufacturing (such as, but not limited to mudguards, overlays, heel counter, heel collar, toe box, closure system (shoe laces. Velcro, elastic and the like, etc.)

In embodiments, the partially manufactured shoe is made or configured to accommodate a custom midsole by extending or heightening the uppers of the partially manufactured shoe when compared to a conventional shoe. Where the uppers comprise straps, such as in a wedge sandal or sandal, the straps are heightened or extended as compared to a conventional shoe to accommodate the custom midsole. For example, the uppers are extended or heightened to accommodate the thickness of a custom midsole according to an embodiment. Extending or heightening the uppers to accommodate the custom midsole also helps to stably accommodate the custom midsole and comfortably fit the user's foot. In an embodiment, extending or heightening the uppers serves to enclose the entirety of the custom midsole in the interior of a shoe made according to an embodiment so that the custom midsole is not visible in a closed shoe, unless the upper material is transparent. In an embodiment, the portion of the shoe where shoe laces (or any other closure method) are conventionally found is designed such that the uppers are easily expanded and contracted to accommodate for thicker or thinner custom midsoles.

In embodiments, the collar of the partially manufactured shoe, if there is one, is lowered in the area of the malleoli when compared to a conventional shoe to accommodate the custom midsole, in particular, the thickness of the custom midsole. Lowering the collar allows for maximal customization of the thickness of the custom midsole as it avoids irritation to the skin overlying the ankle malleoli if a wearer selects a thin custom midsole. In alternative embodiments, different styles of shoes are made that are intended for thin or thick custom midsoles. In embodiments, different shoe styles are made to accept standardized thicknesses and shapes of midsoles after being customized. For example, running shoes typically have a standard for heel to toe drop, toe spring and overall thickness of the midsole that varies from heel to toe. The shoe can be manufactured to accept a standardized toe spring and thickness of custom midsole, which would have the top, or dorsal surface, customized.

For example, in embodiments the “base thickness” of the custom midsole in athletic shoes can range from 3 mm (minimalist style) to 45 mm (maximalist style shoes) as this is currently the general range of conventional midsole thicknesses in athletic shoes. In a women's dress shoe, for example, the base thickness of the midsole layer can be expected to be thinner (1-4 mm) but can also be much thicker depending on the style. The custom midsole will generally vary from the traditional midsole because it will have the ability to conform to the wearer's foot and will have the potential to be modified to correct a wearer's foot alignment as is done in the art of custom foot orthotic making. Customization will cause the midsole to be thicker than the selected “base thickness”, for example, the arch is often the highest portion of the foot from the ground and will result in the midsole being thicker than the “base thickness” in this area if the midsole is made to fully conform to the wearer's foot.

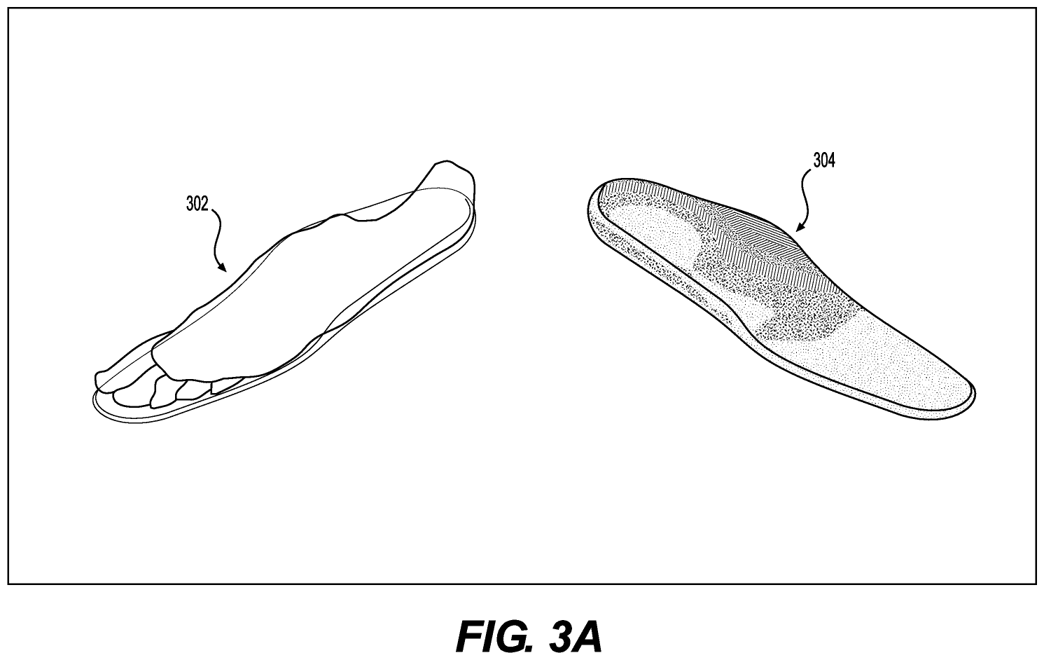

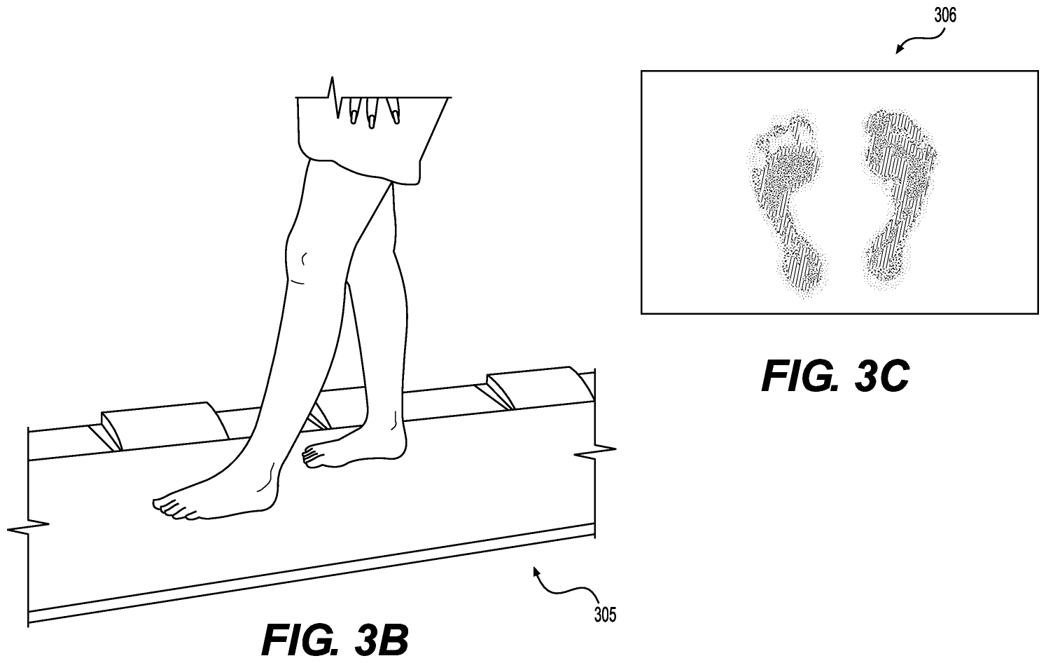

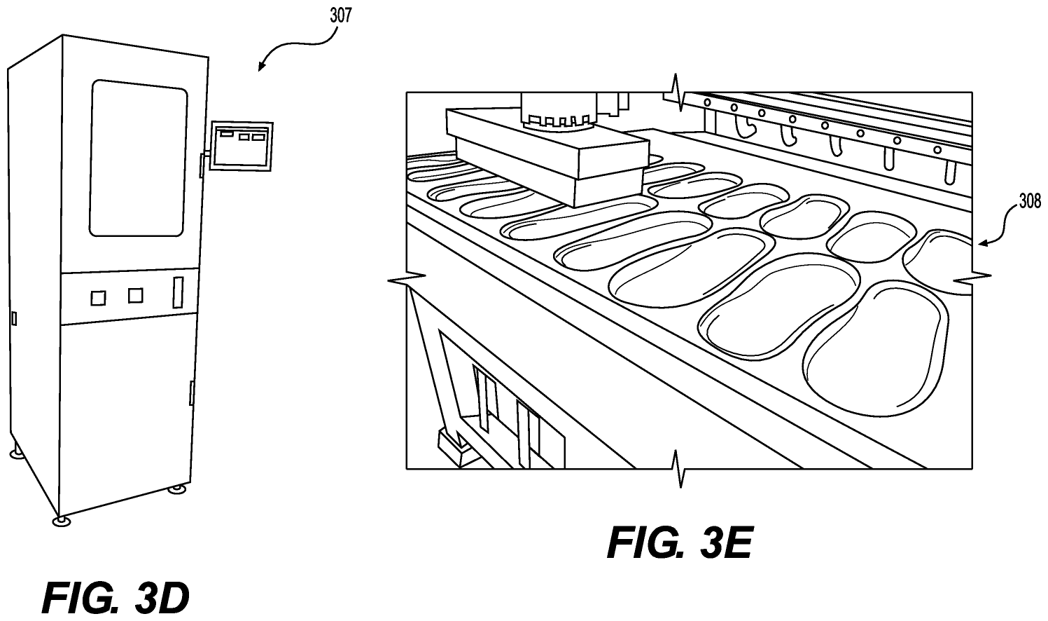

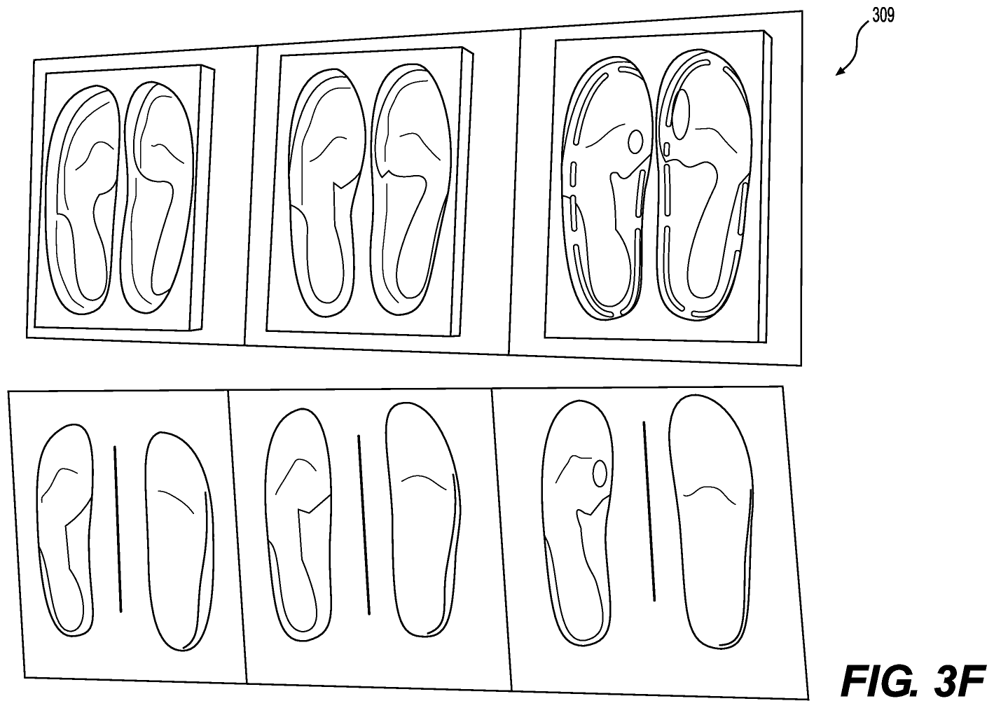

In step 104, an image or scan of the bottom of the user's foot 302 is obtained as illustrated in FIG. 3A. Such an image or scan can be obtained with a foot scanner or imager 208. Any device that can produce an electronic image or scan of the user's foot 302 can be used, including for example, a personal imaging device such as a camera, smartphone camera, laptop camera, notebook camera, tablet camera, scanning device or other device that can be used to obtain a scan of the user's foot. Exemplary such scanners include, without limitation the Voxelcare 2D Foot Scanner and the Voxelcare 3D Laser Foot Scanner, both available from Voxelcare, S. L. of Alicante, Spain. Software applications that work in conjunction with foot scanner or imager 208 are available that can assist users in obtaining a satisfactory image. Exemplary such applications include, without limitation, Foot ID foot and ankle scanning software available from Foot in Motion, Inc. of Riverside, Calif., or FACE ID biometric authentication and verification software with TRUEDEPTH camera available from Apple, Inc. of Cupertino, Calif. (FACE ID and TRUEDEPTH are registered trademarks of Apple. Inc. of Cupertino. Calif.) can be used.

In another embodiment, a mold of the user's foot is obtained and used to obtain the electronic scan or image of the foot. Such a mold can be made using plaster of paris, fiberglass casting tape, foam, or any other moldable material. This mold can then be imaged by foot scanning or imaging device 208, which converts the contour of the mold to an electronic image. An exemplary scanner 208 for such use is the Voxelcare 3D Laser Foot Scanner available from Voxelcare. S. L. of Alicante, Spain.

In another embodiment, as illustrated in FIGS. 3B and 3C, a scan or image of the bottom of the user's foot 302 is obtained and used in conjunction with an electronic pedobarograph or baropedometer image 306 of the user's foot to design the custom midsole. In such an embodiment, a user walks on the pedobarograph or baropedometer pressure matts 305 and an electronic image 306 is generated. This electronic image provides data on pressure distribution where the foot contacts the ground. An optional device exists that resembles an insole that can be temporarily inserted into a user's shoe or shoes to obtain desired foot pressure data. An exemplary such image 306 of a user's pressure distribution where the foot contacts the ground is illustrated in FIG. 3C. Image 306 can be a static or dynamic electronic image showing the pressure distribution throughout a user's foot. Using a pedobarograph or baropedometer provides more detailed information for assessing a user's biomechanics. Such information can be used in conjunction with the electronic image of a foot scan 302 to provide additional information to assist in designing a custom midsole according to an embodiment. In another embodiment, the information obtained from the pedobarograph or baropedometer, with or without optoelectronic systems can be entered into a computer algorithm which can be automated to recommend the design of the midsole eliminating the need for a user to design said insole. For example, and without limitation, baropodometric devices available from Diasu, such as the Diasu Ultrasensor 3D and Ultrasensor 3D Diagnostica available from Diasu of Rome. Italy, can be used to obtain information to be used in the design of a custom midsole as described herein.

Any of these imaging methods can be performed by a professional who specializes in the art of orthotics, such as a podiatrist, orthotist, orthopedic, or any technician trained in the art. In this way, the user is relieved of having to obtain the image themselves. Further, optimal foot positioning during imaging can be achieved. Moreover, the custom midsole of embodiments can be designed and/or prescribed by such a professional to relieve the wearer of such design.

In step 106, a custom midsole is designed according to an embodiment. The custom midsole can be designed by a professional or by a user. In an embodiment, a custom midsole is designed using a custom midsole design system 210 such as a computer-aided design (CAD) system that is configured to design a custom midsole in accordance with a number of midsole customization parameters. The amount of customization using custom midsole design system 210 is optional, for example, the midsole can be simply designed to conform to the user's arch and not have any modifications applied that are known in the art of custom foot orthotic making.

Although all modifications known to the art of custom foot orthotic making can be applied to the custom midsole in embodiments of this invention, midsole modifications known to the art cannot be applied to conventional custom foot orthotics. For example, software does not exist for the complete CAD design of a custom midsole, which includes all modifications known to the art of custom foot orthotic making and midsole making/midsole modifications. Current foot orthotic CAD software requires modification to allow for the design of the complete custom midsole. Examples of CAD software modifications that can be applied to custom midsoles in an embodiment of this invention include, but are not limited to: allowing for significant variations of heel to toe drop, allowing for a toe spring, allowing for any type of rocker sole (such as forefoot rocker, heel to toe rocker, rearfoot rocker), allowing for a SACH (Solid Ankle Cushion Heel), and allowing for significant variations in overall thickness.

When designing a custom midsole according to an embodiment, uses of the shoe are extremely important to consider. For example, the surface that a person uses the shoe on often dictates the desired thickness of the midsole layer. A person who uses the shoe on hard surfaces, such as pavement, will often want and require a thicker, more shock absorptive midsole for cushioning compared to a person who uses the shoe on a grassy field, spongy track, or padded carpeting.

Whether customized by the user, a professional, or determined by CAD system 210, a custom midsole can be customized according to a number of customization parameters. These parameters include, but are not limited to, arch height, heel cup depth, heel-to-toe drop, toe spring, rocker sole, midsole thickness. SACH (Solid Ankle Cushion Heel), apertures, flanges, metatarsal padding, dancers padding, toe crests, toe or foot fill (as used with partial foot amputations), heel wedges or skives, Blake inversion technique, clips, forefoot or rearfoot posting, heel spur pad, first metatarsal cutout. Morton's extension, reverse Morton's extension, neuroma pad, kinetic wedging, and metatarsal bar.

In an embodiment, a shoe includes a full or partial shank or Morton's extension to the interior or exterior of the shoe or under the surface of the custom midsole. In such embodiment, the full or partial shank or Morton's extension is made of a rigid material. Exemplary rigid materials include, but are not limited to, carbon fiber, plastic, fiberglass, metal and Kevlar.

Further, different materials having different properties can be used for all or portions of the custom midsole. As such, the custom midsole can comprise a single material or different materials having different properties. One such property is material density as discussed below. If more data is desired for the design of the custom, the pedobarograph or baropodometer image 306 can be used in conjunction with foot model 302 to complete the design.

These customizations can be for increasing comfort, to correct for under- or over-pronation or other foot issues, to provide additional arch support, accommodate foot deformity, to accommodate a user having different leg lengths, alleviate ankle, knee, hip, or low back pain, to offload areas of excessive pressure, offload areas that are ulcerative or pre-ulcerative (such as can occur in a neuropathic foot), or for any other reasons, including combinations of reasons.

In an embodiment, any or all of the customization parameters can be standard regardless of style of shoe. In another embodiment, the customization parameters can be set depending on the style of the shoe selected by the user. In another embodiment, each or any of the customization parameters can be independently adjusted by the designer of the custom midsole. For example, default values can be provided for any, all, or none of the customization design parameters. In an embodiment, such default custom design parameters are stored in a configuration file. In an embodiment, standard customization design parameters are used.

In another embodiment, for example, when a user designs the custom midsole, custom midsole design system 210 is a computer (or other computing devices such as a smartphone or tablet) having executing thereon an application to guide the user in the design of a custom midsole. In an embodiment, the application is configured to automatically categorize a picture of a user's foot into flat, neutral, or high arch. Based on this categorization, the application recommends a midsole design for the user. In an embodiment, the application allows the user to choose to modify or delete a set of recommended parameters for design of the custom midsole, or add additional parameters to incorporate into the design of the custom midsole.

In another embodiment, an application executing on a computer (or other computing devices such as a smartphone or tablet) queries the user for preferences, and then suggests or provides a custom midsole design in accordance with the user's preferences. In such embodiment, for example, the application displays one or more foot images to the user on a display screen associated with the computer, and queries the user as to which foot image or images most closely resembles the user's foot when standing. The foot images, for example, can represent flat, neutral and high arch foot types. Once the foot type is determined, the application provides a series of queries to guide the user in selecting modifications or additional customizations that would be helpful for the user's foot type. For example, the application may suggest the user select such custom midsole design parameters as a medial heel wedge or skive and medial and lateral flange for a severe flat foot; a metatarsal pad for pain on the ball of the foot; or a heel lift for Achilles tendon pain or for plantar fasciitis. Each modification has an indication known to those skilled in the art. The indication for each modification can be listed to guide the user's selection. In an embodiment, the application has a help feature that will allow the user to be provided a description of each customization design parameter.

In an alternative embodiment, where foot images are shown to the user, after the user selects the image or images most closely resembling their foot type (or this can be done automatically using software that matches the user's scan to a foot type), the user is provided standardized midsole parameters (such as midsole thickness, heel to toe drop etc.) that are used in various conventional running shoe midsoles (minimalist, maximalist, neutral, motion control or cushion). The custom midsole will be manufactured off of the user's foot scan so that the arch is custom. The user can select to use the recommendations provided, or modify or add to the recommended parameters to further customize the custom midsole.

Where the user desires a more detailed or prescription equivalent type of midsole (functionally equivalent to custom foot orthotics), the user may choose to have their foot evaluated and/or imaged and the midsole with overlying insole designed by a professional or technician who is knowledgeable in the field of custom foot orthotic prescription writing/design.

Even when a user designs their own custom midsole, the user may desire a more detailed evaluation or review by a professional such as a podiatrist or other professional specializing in orthotics, insoles, or medical issues that can be resolved with a custom midsole according to embodiments. For example, such a professional can review the user-selected midsole customization parameters, and make recommendations for adjusting them for the user's needs. To do this, the professional may conduct a biomechanical exam or can make recommendations virtually.

In another embodiment, using more sensitive equipment such as force plates (pedobarograph or baropodometer) with or without optoelectronic systems, in combination with a foot scan, the appropriate midsole design for the wearer's unique foot structure may be automated via a computer algorithm. Such a computer system would include software configured to create custom midsole model 304 according to customizable midsole parameters as described herein.

The above-described modification options for a custom midsole according to an embodiment are interchangeable. For example, a user may scan their own foot with a smartphone or tablet, send the scanned image to a professional via email, text, chat, or other electronic communication, and then have a professional evaluate their foot and complete the prescription/design of the midsole for them. If only a midsole that has a customized arch is desired, no additional modifications need to be applied, and a custom midsole can be manufactured by using standard parameters for midsoles that are routinely used in conventional shoes and simply designing midsole, with the use of the CAD system, so that the arch matches the scanned image of the wearer's foot. In an embodiment, the designed midsole and or foot image can be stored electronically by any party for future easy reordering or for new designs and/or modifications without having to repeat the foot imaging step. In addition to storing the custom midsole image, a configuration or parameter selection file can store any customizations and/or customization parameters.

In step 107, the foot image, foot model 302, and custom midsole design 304 is stored by the consumer, designer and/or the manufacturer electronically for easy future reorders or as a starting point for new, additional or different modifications. This precludes the need for rescanning or redesigning unless a change in the consumer's foot structure occurs.

In step 108, the materials for fabricating a custom midsole according to an embodiment are selected. The material or materials selected often depend on use of the shoe and the user's foot type. For example, if greater support is desired, a firmer material can be selected. If more cushion is desired, a softer material can be selected. If the wearer has a flat foot that necessitates a motion control type of sole, a firmer material can be utilized in the arch and medial foot area, and a softer material can be used laterally as is known in the art of motion control midsole making. If the user overpronates, a firmer material can be used in the arch area of the custom midsole, and a softer material used more laterally on the foot. Such a design of the custom midsole will help to decrease the user's pronation. Also, if the user desires a shoe that does not bend easily in the arch, the custom midsole can be designed with a firmer material in the arch area.

Unlimited combinations of materials exist which when combined with the design of the custom midsole can maximize foot function or accommodate foot deformity. The particular material or combination of materials to be used to fabricate a custom midsole according to an embodiment can be selected by the user, a professional, a manufacturer or technician, or other appropriate person associated with the manufacture of a shoe having a custom midsole according to embodiments.

Any millable, heat moldable or 3D printable material can be used to fabricate a custom midsole according to an embodiment. In an embodiment, various materials or combinations of materials can be used as described above. In an embodiment, various densities of materials can be used alone or in combination to optimize the function of the midsole for the user. Combinations of materials may be selected when the wearer wishes to have more support (firmer material) or more give (softer material) as known in the art of athletic shoe sole or custom foot orthotic making.

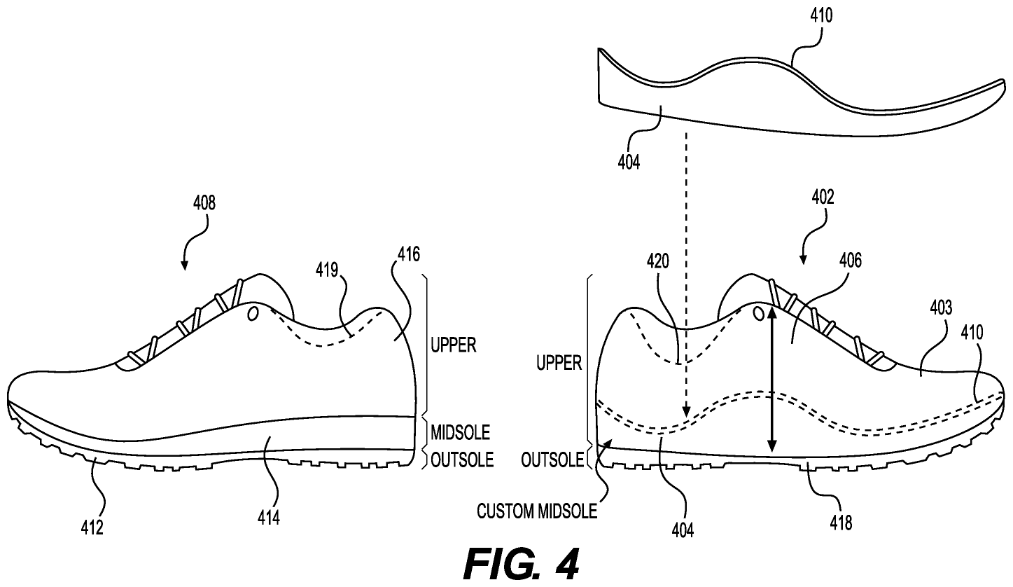

In step 110, the custom midsole designed in step 106 is fabricated using a custom midsole fabrication system 212 with the materials selected in step 108. In an embodiment, custom midsole fabrication system 212 includes using computer-aided manufacture (CAM) technology to 3D print or mill the custom midsole. Using a CAM system, the custom midsole is either directly milled or 3D printed. Using custom midsole fabrication system 212, a custom midsole according to an embodiment, can be manufactured in as little as 10 minutes. Exemplary such custom midsoles include, without limitation, custom midsole 404 illustrated and described with respect to FIG. 4, and custom midsole 503 illustrated and described with respect to FIGS. 5B-5E. FIGS. 3D-3F illustrates an example of a single pair milling machine 307 and a multiple pair midsole milling machine 308. Image 309 shows milled custom midsole, not yet removed from the block of material.

Milling machines and 3D printers that can be adapted for milling or 3D printing a custom midsole according to embodiments disclosed herein are available from companies such as Diasu, VoxelCare and Vorum, for example, and without limitation, the VCM250 (milling machine) and the VXC3DP 1.0 FDM printing unit (3d printer) available from Voxelcare, S. L. of Alicante, Spain. However, there are some issues to consider when adapting them for use in manufacturing a custom midsole as described herein. For example, a thicker material blank will need to be used for milling a custom midsole, as compared to a custom foot orthotic, to allow for all of the desired modifications, as described in embodiments of this invention. Further, if the shoe type selected is flexible, the shoe will conform to the fabricated custom midsole. If the shoe selected is not flexible and has a toe spring, the undersurface of the custom midsole can either be milled or printed to fit the toe spring in the partially manufactured shoe. Alternatively, the material selected for the custom midsole can be pre-formed to fit the shoe on its bottom and milled on its top to meet the criteria of the custom midsole design, or 3D printed on top of a preformed template that matches the selected shoe style structure. For example, an EVA foam blank can be pre shaped on the undersurface to have the desired toe spring or rocker sole. This can be placed in the milling machine and the top/dorsal portion can be milled as required per the custom midsole design to match the user's foot. Alternatively, if a 3D printer is being used, a plate can be placed in the 3D printer that has the desired shape of the rocker sole/toe spring. When the 3D printer prints out the midsole, the liquified printing material will be squirted onto the plate that will support the liquified material until it hardens into the shape of the custom midsole. Alternatively, the desired shape can be directly 3D printed.

In an embodiment, an insole is adhered to or used to cover the custom midsole. Any material may be used for this purpose. In such embodiment, the insole takes on the contour of the upper/dorsal surface of the customized midsole.

In step 112, the midsole and optional insole are placed into a partially manufactured shoe designed to accommodate the midsole and optional insole to form a completed shoe 216. Note that the insole will be placed or adhered to the dorsal surface of the custom midsole in completed shoe 216 rather than being placed or adhered to the dorsal surface of the shoe lasting, as is seen in a conventional athletic soled shoe (or the equivalent in other shoe types). Any type of adherent can be used when the midsole is adhered to the outsole, partial midsole, or shoe lasting (or equivalent), including, but not limited to, glue, rubber cement, Velcro, or snaps. Depending on desired use, the adherent can be permanent or temporary.

If the selected shoe type is a sandal or a wedge sandal, the straps may need to be adhered between the midsole and outsole. The straps can optionally be adjusted prior to adhering so their length will be customized to the wearer. Alternatively, the straps can be set at a standard length or will use options such as buckles. Velcro or elastic so that the length will be flexible. In an embodiment, the straps can be manufactured so that they are directly adhered to the outsole of the shoe. In another embodiment, the straps can be manufactured through 3D printing so that they will be printed with and attached to the midsole layer. This described midsole layer may or may not have an outsole or insole added.

In step 114, completed shoe 216 is provided to the user. When manufacturing a shoe according to an embodiment, complete shoe 216 with the custom midsole is immediately available to the user if the manufacturing equipment is onsite, such as in the user's home, a kiosk, in a shoe store or in a professional office who stocks partially manufactured shoes as described above. Alternately, the shoes with the custom midsole and optional insole, if included, can be mailed or otherwise delivered to the user from where they were manufactured.

Although steps 101-114 of the process for manufacturing a shoe with a custom midsole described herein can be completed at different locations, a greater efficiency may be achieved in some applications if done at one location, for example, in a person's home, in a shoe store, or at a professional's office.

A wearer can opt to perform steps 101-114 at home, for example, using their smartphone or tablet to image their foot and design their midsole, and a 3D printer to fabricate the customized midsole. Once fabricated, the wearer can optionally add an insole to the customized midsole. The customized midsole and optional insole, if included, is then inserted into a premade shoe. If desired, the user can more permanently attach the customized midsole to the premade shoe using an adherent such as, without limitation, glue, rubber cement, snaps or Velcro.

Alternatively, the user can order the shoe online by electronically sending their designed midsole image (and any custom design parameter file or other configuration file) to a shoe store, manufacturer, or fulfillment center that has the equipment to manufacture a customized midsole according to embodiments using the materials selected by the user. Preferably, the premade shoe will be at the same location as the custom midsole is manufactured so that the shoe can be completely assembled at the same location. Once assembled, the completed shoe is distributed to the consumer.

Alternatively, a consumer can choose to have their foot evaluated by a professional who is knowledgeable in the art of custom foot orthotic prescribing/manufacturing, in which case the online order may be completed by the professional. In another embodiment, where a professional has the entire system in their office (pre-made shoes without a midsole, scanner, CAD/CAM software, an additive manufacturing device (such as a 3-D printer) or milling device, with all materials needed for the midsole and insole if included), the entire process can be completed within the professional setting.

Larger scale machines are available for fulfillment type warehouses or in a factory setting that can produce many pairs of custom midsoles simultaneously. Various companies such as Voxelcare, Diasu, and Vorum, develop and sell complete systems that include a foot scanner, software, and a CNC milling machine or 3D printer (or other types of additive manufacturing devices) that can be adapted to assist in production of custom midsoles according to an embodiment, including the considerations described above, for example, and without limitation, the VCM250 (milling machine) and the VXC3DP 1.0 FDM printing unit (3d printer) available from Voxelcare. S. L. of Alicante, Spain.

The steps illustrated in FIG. 1 are not fixed in their order and can be completed at any time where possible. For example, the scan and design of the midsole can be stored as soon as steps 104 and 106 are completed. The wearer can select a shoe type and style in step 101 preferably any time before the custom midsole is manufactured. In an embodiment, a partially manufactured shoe can be made in step 103 prior to selecting a shoe style in step 101. Other orders for various of the steps may be possible in a particular embodiment.

FIG. 4 compares conventional shoes (not sandals or wedge sandals) with various types of corresponding shoes according to embodiments. Referring to FIG. 4, a completed shoe 402 manufactured according to an embodiment is compared to a conventionally manufactured shoe 408. Shoe 402 can be any type of shoe, including for example, an athletic shoe, a cleat, a boot, a dress shoe, a casual shoe, a high-heeled shoe, a boot, or any other type of shoe, that has a midsole in its conventional form which is partially or fully omitted from the exterior sole portion of the shoe during manufacturing, The midsole is then customized to a wearer's foot, optionally modified according to the art of custom foot orthotic and midsole making, and relocated from the exterior sole portion of the shoe (as in a conventional shoe) to the interior of the shoe (as described in embodiments). Referring back to FIG. 4, conventional shoe 408 comprises a midsole 414, uppers 416, and an outsole 412.

As illustrated in FIG. 4, completed shoe 402 according to an embodiment comprises a partially manufactured shoe 403, a custom midsole 404, and optional insole 410. Partially manufactured shoe 403 includes uppers 406 and an outsole 418, and possibly a shoe lasting. In an embodiment, partially manufactured shoe 403 may include a portion of a midsole that is not customized. Such midsole portion may be wholly, partially, or not visible. As such, shoe 402 does not initially include a midsole layer (or may include a partial midsole layer). A custom midsole 404, designed according to the wearer's needs as described above, is added to shoe 402 after its partial manufacture. Uppers 406 have been heightened or extended when compared to the uppers 416 of a conventional shoe 408 so that the custom midsole 404 fits within shoe 402. The only part of completed shoe 402 that is made to order (customized) is custom midsole 404. However, in an embodiment, one or more other components of completed shoe 402 may be customized. In an embodiment, optionally, an insole 410 is added to custom midsole 404. In an embodiment, custom midsole 404 is adhered to outsole 418, or, if present, to the shoe lasting or other thin layer of material that separates the interior portion of the shoe from the sole layer, using an adherent. The adherent can be glue, rubber cement, or any other adherent that permanently or removably attaches custom midsole 404 to outsole 418, partial midsole (if present), or to the shoe lasting or other thin layer of material that separates the interior portion of the shoe from the sole layer (if present). Glue, rubber cement, and the like, can be applied in lines, beads, both or other way of applying such adherents. In an alternate embodiment, custom midsole 404 is not adhered and is just inserted into a shoe and sits atop outsole 418, or a partial midsole if present.

When viewing the exterior of shoe 402 made according to an embodiment, uppers 406 appear as if they are directly attached to outsole 418. In such embodiment, custom midsole 404 is not visible. In contrast, when viewing the exterior of conventional shoe 408, conventional midsole 414 visibly appears sandwiched between outsole 412 on the undersurface and the uppers 416 from the top surface. Uppers 416 on conventional shoe 408 are not heightened or extended because during manufacturing nothing other than the insole that comes within the shoe and the wearer's foot are intended to be in the interior of conventional shoe 408.

Further, because shoe 402 is manufactured with the addition of customized midsole 404 and optional insole 410, if included, in mind, the thickness of custom midsole 404 and the amount of material that is available for customization is significantly greater than that available in the interior of a conventional shoe 408. In an embodiment, collar 420 of a shoe 402 manufactured according to an embodiment is lowered or deepened compared to that of conventional shoe 408 to accommodate for a thin custom midsole that would otherwise rub against the wearer's ankle malleoli, and could lead to discomfort. In another embodiment in which a thin custom midsole is used, and the thinness of the midsole makes sufficient tightening of the uppers difficult or impossible, the lace cage of the shoe is extended to the distal aspect of the shoe vamp to allow for tightening of the entire upper.

In embodiments, a shoe having straps for uppers, such as a sandal or wedge sandal, is partially manufactured with all or a portion of the midsole omitted, and with heightened uppers so that a customized midsole with optional overlying insole can be rapidly added and dispensed to the wearer. FIG. 5A illustrates a conventional shoe 504 using straps for uppers. Conventional shoe 504 comprises an insole 506, a midsole 508, an outsole 510, and straps 511.

FIG. 5E illustrates a complete shoe 530 that uses straps for uppers that comprises a custom midsole 503 according to an embodiment. Such a shoe 530 can be any shoe that uses straps for an upper including sandals, wedge sandals, and some high-heeled shoes. As illustrated in FIG. 5E, complete shoe 530 comprises straps 514, and possibly portion 514a, a custom midsole 503, an insole 505, which is optional, and an outsole 516a (sandal) or 516b (wedge sandal). Straps 514 can be for a “slide” or “slide on” type shoe or with strap portion 514a for a “thong” type shoe 530. The strap configuration is not limited to those displayed in the figures. For example, the straps can be extended around the ankle. In a thong type shoe 530 straps 514 include strap portion 514a and a toe portion 525 of strap portion 514a for anchoring strap 514 to custom midsole 503 and/or outsole 516a or 516b. In addition, for a thong type shoe 530, an optional split or slit 521 may be present in custom midsole 503 and optional insole 505 to facilitate insertion of custom midsole 503 and optional insole 505 into shoe 530. In an embodiment, the end of slit 521 nearest toe portion 525 of strap 514 has a cut out 522 to go around toe portion 525 of strap 514 to avoid separation of slit 521 at its other end. Slit 521 allows for more rapid insertion of custom midsole 503 into completed shoe 530.

FIG. 5B illustrates a partially manufactured shoe 502a using straps as uppers made according to an embodiment. Partially manufactured shoe 502a comprises an outsole 516a (sandal) or 516b (wedge sandal), and straps 514. Partially manufactured shoe 502a is used to manufacture what is commonly referred to as a thong sandal or thong wedge sandal. Partially manufactured shoe 502a configured with outsole 516a will result in what is commonly referred to as a thong sandal when a custom midsole 503 and, if desired, an optional insole 505, is inserted or adhered on top of outsole 516a. Partially manufactured shoe 502a configured with outsole 516b will result in what is commonly referred to as a wedge sandal when a custom midsole 503, and, if desired, an optional insole 505, is inserted or adhered on top of outsole 516b.

FIG. 5D illustrates a partially manufactured shoe 502b using straps as uppers made according to an embodiment. Partially manufactured shoe 502b comprises a sandal outsole 516a or wedge outsole 516b, and straps 514. Partially manufactured shoe 502b is used to manufacture what is commonly referred to as a slide or slide on sandal or slide or slide on wedge sandal. Partially manufactured shoe 502b configured with outsole 516a will result in what is commonly referred to as a slide or slide on sandal when a custom midsole 503 and, if desired, an optional insole 505, is inserted or adhered on top of outsole 516a. Partially manufactured shoe 502b configured with outsole 516b will result in what is commonly referred to as a slide or slide on wedge sandal when a custom midsole 503 and, if desired, an optional insole 505 is inserted or adhered on top of outsole 516b.

FIG. 5C illustrates a custom midsole 503 designed and fabricated as described above for insertion into a partially manufactured shoe with straps as uppers such as partially manufactured shoes 502a or 502b. As illustrated in FIG. 5C, custom midsole 503 can have attached to it an optional insole 505. In addition, as described below for insertion into a thong type sandal or wedge sandal, custom midsole can have a slit or slice 521 cut into it to facilitate insertion of custom midsole 503 and optional insole 505 into shoe 530. In an embodiment, the end of slit 521 nearest toe portion 525 of strap 514 has a cut out to go around toe portion 525 of strap 514 to avoid separation of slit 521 at its other end.

To accommodate custom midsole 503 and optional insole 505, if included, in an embodiment, straps 514 of partially manufactured shoes 502a or 502b made according to an embodiment are heightened as compared to straps 511 in a conventional shoe 504 using straps 511. In an embodiment, straps/uppers 514 are manufactured so that they are part of the partially manufactured shoe/sandal/wedge sandal and are attached to outsole 516a or 516b (or to partial midsole or between the outsole and partial midsole if present). In an embodiment, a midsole 503 is adhered to outsole 516a or 516b (or to the partial midsole or lasting if present) using an adherent 515. Any type of adherent can be used when the midsole is adhered to the outsole, partial midsole, or shoe lasting (or equivalent), including, but not limited to, glue, rubber cement, Velcro, or snaps. Depending on desired use, the adherent can be permanent or temporary. Glue, rubber cement, and the like, can be applied in lines, beads, both or other way of applying such adherents. This will allow partially manufactured shoe 502a or 502b to have the custom midsole 503 with optional insole 505 rapidly placed into or adhered, with adherent 515 to outsole 516a or 516b and dispensed to the wearer.

In another embodiment, the toe portion 525 of the “thong strap” upper 514 can be left unattached in the partially manufactured sandal/wedge sandal 502a and pierced through custom midsole 503 and optionally also through outsole 516a or 516b and affixed with adherent 515 or with any method known in the art of shoe making.

In an embodiment, midsole 503 is inserted into a shoe so that it will sit atop outsole 516a or 516b, or a partial midsole if present. In an embodiment, the partially manufactured shoe 502a or 502b may have a “lip” 520 to assist in containing the custom midsole.

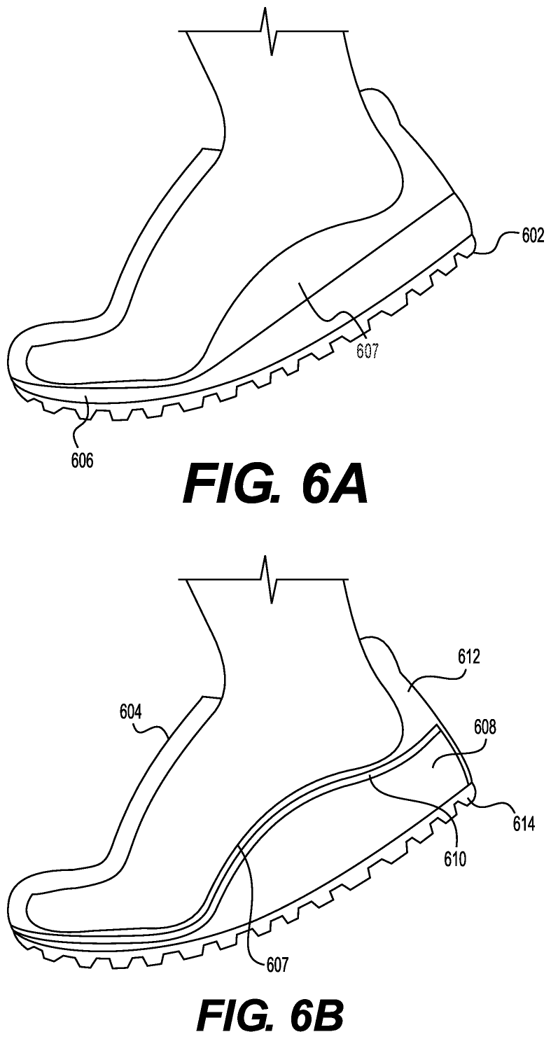

FIG. 6A illustrates a sagittal profile slice of a conventional shoe 602. FIG. 6B illustrates a sagittal profile slice of a shoe 604 according to an embodiment. As illustrated in FIG. 6A, the arch portion of midsole 606 of conventional shoe 602 is not in contact with the arch of the user's foot 607. FIG. 6B illustrates a shoe 604 with a custom midsole 608 and optional insole 610, and an outsole 614. As illustrated in FIG. 6B, custom midsole 608, with optional insole 610, if desired, conforms to the sole of the wearer's foot. In such embodiment, the arch portion of custom midsole 608 is in contact with the arch 607 of the wearer's foot. Due to shoe 604 according to an embodiment being designed with heightened uppers 612, the wearer's foot fits comfortably within shoe 604 with use of the custom midsole 608.

In an embodiment, a scanner is used to scan the wearer's foot or a mold of the wearer's foot. Any other apparatus may be used to obtain an electronic representation of the sole of the wearer's foot. The scanned image is converted into an electronic foot model FIG. 3, 302. The scanned image along with the CAD custom designed custom midsole FIG. 3, 304 are electronically stored for future reorder or modification.

In embodiments, other extensions of a conventional shoe may be required to accommodate the custom midsole. For example, the length or width of a conventional shoe may need to be increased to accommodate insertion of the custom midsole into the completed shoe.

Embodiments can apply the process described herein for customizing even conventional shoes. For example, the user can select a conventional shoe, the foot can be scanned, an insole can be milled or printed and placed within the shoe, and the shoe can be dispensed with a custom insole.

The foregoing disclosure of the preferred embodiments has been presented for the purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

What is claimed is:

1. A shoe, comprising:
a partially manufactured shoe having a midsole layer that is partially or fully omitted; and
a custom midsole that is inserted into the shoe.

2. The shoe recited in claim 1, further comprising an insole.

3. The shoe recited in claim 1, wherein the partially manufactured shoe is configured such that the custom midsole fits within the shoe with sufficient room for a wearer's foot.

4. The shoe recited in claim 1, wherein the collar of the shoe is lowered under the ankle malleolus to prevent irritation if the custom midsole is thin enough that the user's ankle malleoli would rub against the collar of the shoe.

5. The shoe recited in claim 1, wherein the lace cage is extended to the distal aspect of the shoe vamp to allow for tightening of the entire upper.

6. The shoe recited in claim 3, wherein the partially manufactured shoe comprises uppers that are extended or heightened such that the custom midsole fits within the shoe with sufficient room for a wearer's foot.

7. The shoe recited in claim 2, wherein the custom midsole is not visible from the outside of the shoe.

8. The shoe recited in claim 1, wherein the custom midsole is adhered to an interior portion of the shoe.

9. The shoe recited in claim 1, wherein the custom midsole is customized as to one or more of thickness, heel-to-toe drop, toe spring, and rocker sole.

10. The shoe recited in claim 1, further comprising one of a full shank, partial shank and Morton's extension to one of the interior of the shoe and the under surface of the custom midsole, wherein the one of the full shank, partial shank, and Morton's extension is made of a rigid material.

11. The shoe recited in claim 10, wherein the rigid material is one of carbon fiber, metal, fiberglass, Kevlar or plastic.

12. The shoe recited in claim 1, wherein the shoe is one of a sandal and a wedge sandal.

13. The shoe recited in claim 12, wherein the shoe is one of a slide on- or a thong-type shoe.

14. The shoe recited in claim 13, wherein the custom midsole comprises a slit to facilitate insertion of the custom midsole in the shoe.

15. The shoe recited in claim 13, wherein the partially manufactured shoe comprises a lip to facilitate insertion of the custom midsole in the shoe.

16. A method for manufacturing a shoe having a custom midsole, comprising:
partially manufacturing shoes of one or more styles that have one of no midsole and a partial midsole;
selecting a style of shoe from the one or more styles;
fabricating a custom midsole; optionally covering the custom midsole with an insole; and
inserting the custom midsole into the shoe to form a complete shoe, wherein the partially manufactured shoe has uppers that are extended or heightened to accommodate the inserted custom midsole.

17. The method recited in claim 16, further comprising selecting the style of shoe from a catalog or website.

18. The method recited in claim 16, further comprising selecting the style of shoe from a display in a store or other location (such as physicians office).

19. The method recited in claim 16, further comprising:
capturing an image of a wearer's foot;
designing the custom midsole using the captured image of the wearer's foot;
creating a model of the custom midsole based on the design of the custom midsole; and
fabricating the custom midsole based on the model.

20. The method recited in claim 19, further comprising storing for later use one or more of the image of the wearer's foot and the model of the custom midsole.

21. The method recited in claim 16, further comprising adhering the custom midsole to the partially manufactured shoe.
